(19) United States
(12) Patent Application Publication
(10) Pub. No.: US 2018/0361785 A1
(43) Pub. Date: Dec. 20, 2018

(54) BICYCLE RIM WITH ENLARGED OUTER RADIAL EDGES

(71) Applicant: ENVE Composites LLC, Ogden, UT (US)

(72) Inventors: Clint L. Child, Ogden, UT (US); Kevin E. Nelson, Salt Lake City, UT (US); Elias S. Harik, Eden, UT (US); Brett Satterthwaite, Farr West, UT (US)

(21) Appl. No.: 15/626,009

(22) Filed: Jun. 16, 2017

(51) Int. Cl. B60B 21/02; B60B 21/10; B60B 1/00; B60B 21/04

(52) U.S. Cl. CPC B60B 21/025; B60B 2900/212; B60B 21/102; B60B 21/104; B60B 1/003; B60B 21/04; B60B 2360/366; B60B 2360/00; B60B 2360/324; B60B 2360/32; B60B 2360/36; B60B 2360/341; B60B 2360/104; B60B 2360/14; B60B 21/021

(57) ABSTRACT

A bicycle rim for carrying a tire. The rim includes a circumferential tire bed including first and second opposing edge regions a circumferential spoke face, and first and second side walls extending from the spoke face to the first and second edge regions, respectively. The first and second side walls include first and second side wall extensions radially extending from the first and second opposing side regions and terminating at first and second outer radial edges, respectively. Each of the first and second outer radial edges defining a maximum width that is at least 3.8 mm.

### FIELD OF THE INVENTION

The present invention relates to a rim having enlarged outer radial edge surfaces for reducing the likelihood of pinch flats.

### BACKGROUND OF THE INVENTION

Bicycles including road racing bicycles and mountain bicycles are well-known. Bicycles include a frame and a pair of wheels supporting a pair of tires, with each wheel having a hub, a rim and a plurality of spokes connecting the rim to the hub. Road racing bicycles typically use tires having relatively small tire diameters within the range of 18 to 23 mm that provide aerodynamic performance advantages such as reduced drag or wind resistance. In recent years, many tires used in road racing applications have been designed with larger tire diameters up to 32 mm. Mountain bicycles also typically include a wider tire. The wider tires provide improved rolling resistance, greater stability and control. High end bicycles typically seek to reduce the weight of the bicycle including its components. Bicycle rims are no exception. High end bicycle rims are typically designed to be light weight structures, and the wall thickness of rim portions are typically very thin. Many rims also include straight side, side wall designs that in combination with thin wall constructions, provide a substantially flat, narrow and rigid side walls.

The larger diameter tires of bicycles on such high end bicycles can include a significant drawback. When the rider impacts a large object, such as a rock, the larger diameter tire will typically significantly deflect about the rock upon impact. The extreme deflection of the tire pushes, squeezes or pinches a portion of the tire between the rock or object and the narrow side wall of the rim. The pinching of the tire often creates a tire rupture location where the rim side wall cuts into the tire causing a pinch flat or a flat tire.

Accordingly, a need exists to develop a wheel rim and tire combination that provides exception performance and also provides a reduced susceptibility to pinch flats upon impact objects on the road during a ride.

### SUMMARY OF THE INVENTION

The present invention provides a bicycle rim for carrying a tire. The rim includes a circumferential tire bed including first and second opposing edge regions a circumferential spoke face, and first and second side walls extending from the spoke face to the first and second edge regions, respectively. The first and second side walls include first and second side wall extensions radially extending from the first and second opposing side regions and terminating at first and second outer radial edges, respectively. Each of the first and second outer radial edges defining a maximum width that is at least 3.8 mm.

This invention will become more fully understood from the following detailed description, taken in conjunction with the accompanying drawings described herein below, and wherein like reference numerals refer to like parts.

### BRIEF DESCRIPTION OF THE DRAWINGS

FIG. 1 is a side view of a bicycle.

FIG. 2 is a front, side perspective view of a wheel and a tire of the bicycle of FIG. 1.

FIG. 3 is a radial cross-sectional view of a rim and a tire of the wheel and tire of FIG. 2 in accordance with an example implementation of the present invention.

FIG. 4 is a radial cross-sectional view of an example rim and an example tire impacting a rock and creating pinch flat event.

FIG. 5 is a radial cross-section view of a rim in accordance with an implementation of the present invention and an example tire impacting a rock.

FIG. 6 is radial cross-sectional view of a rim in accordance with an alternate implementation of the present invention.

FIG. 7 is radial cross-sectional view of a rim in accordance with another implementation of the present invention.

FIG. 8 is radial cross-sectional view of a rim in accordance with another implementation of the present invention.

FIG. 9 is radial cross-sectional view of a rim in accordance with another implementation of the present invention.

FIG. 10 is radial cross-sectional view of a rim in accordance with another implementation of the present invention.

FIG. 11 is radial cross-sectional view of a rim in accordance with another implementation of the present invention.

FIG. 12 is radial cross-sectional view of a rim in accordance with another implementation of the present invention.

FIG. 13 is radial cross-sectional view of a rim in accordance with another implementation of the present invention.

FIG. 14 is radial cross-sectional view of a rim in accordance with another implementation of the present invention.

FIG. 15 is radial cross-sectional view of a rim in accordance with another implementation of the present invention.

FIG. 16 is radial cross-sectional view of a rim in accordance with another implementation of the present invention.

FIG. 17 is radial cross-sectional view of a rim in accordance with another implementation of the present invention.

FIG. 18 is radial cross-sectional view of a rim in accordance with another implementation of the present invention.

FIG. 19 is radial cross-sectional view of a rim in accordance with another implementation of the present invention.

FIG. 20 is radial cross-sectional view of a rim in accordance with another implementation of the present invention.

FIG. 21 is radial cross-sectional view of a rim in accordance with another implementation of the present invention.

### DETAILED DESCRIPTION OF THE INVENTION

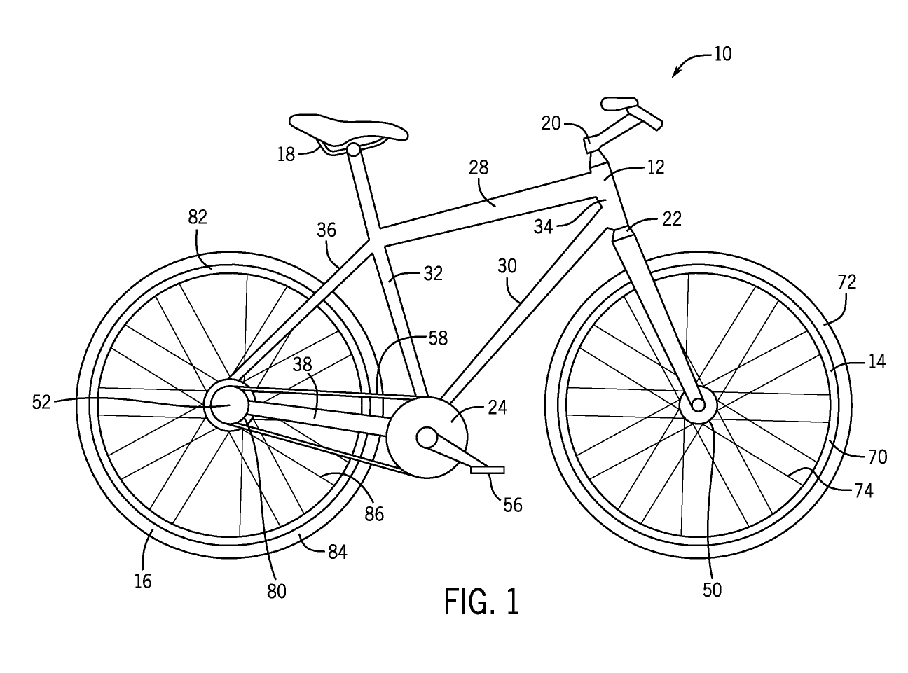

Referring to FIG. 1, a bicycle is generally indicated at 10. The bicycle 10 includes a frame 12 that supports a rider, forward and rearward wheel assemblies 14 and 16, a seat assembly 18, a handlebar assembly 20, a fork assembly 22 and a crank set 24. The frame 12 generally includes a top tube 28, a down tube 30, a seat tube 32, a head tube 34, a seat stay 36 and a chain stay 38. The seat assembly 18 and the handlebar assembly 20 are coupled to the seat tube 32 and the head tube 34, respectively. The handle bar assembly 20 includes a stem that passes through the head tube to engage a fork crown of the fork assembly 22 that supports the front wheel assembly 14.

The rear wheel assembly 16 is positioned generally concentrically about a rear axle 52 such that rear wheel assembly 16 rotates about the rear axle 52. The seat stay 36 and the chain stay 38 support the rear wheel assembly 16. The crankset 24 includes a crank arm and pair of pedals 56 that are operably connected to a chain 58 via a chain ring or sprocket. Rotation of the crank aim communicates a drive force to the rear wheel assembly 16 of bicycle 10 having a gear cluster.

The front wheel assembly 14 includes the front hub 50, an annular rim 70, a tire 72 mounted to the rim 70 and a plurality of spokes 74 extending from the hub 50 to the rim 70. Similarly, the rear wheel assembly 16 includes a rear hub 80 connected to the frame 12 at the rear axle 52, a rear rim 82, a rear tire 84 and a plurality of rear spokes 86 connecting the rear hub 80 to the rear rim 82.

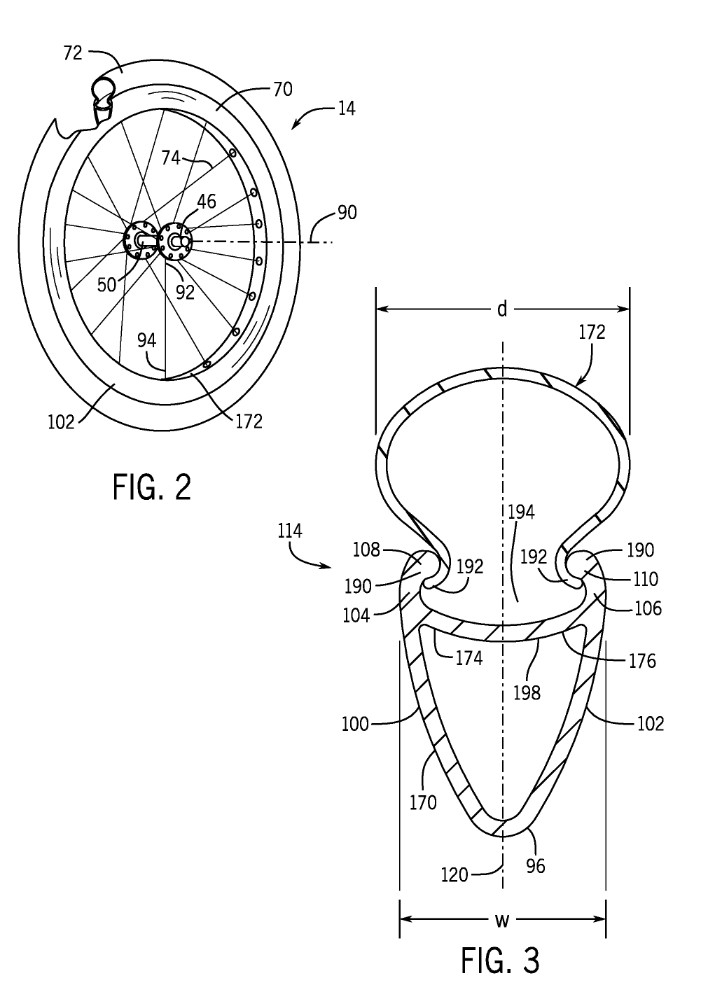

FIG. 2 illustrates the main components of the front wheel assembly 14. The present invention will be described with respect to the front wheel assembly 14. However, one of skill in the art would understand, and it is contemplated that, the features, description and example implementations of the present invention described with respect to the front wheel assembly 14 also apply to the rear wheel assembly 16. It is also contemplated that the front wheel assembly 14 may include one example implementation or feature of the present invention and the rear wheel assembly 16 may include the same or a different implementation or feature of the present invention.

A front axle 46 extends about a front axis 90. The front hub 50 rotatably engages the front axle 46. The plurality of spokes 74 include first ends 92 that are coupled to the front hub 50 and second ends 94 that are coupled to a spoke face 96 of the rim 70. The rim 70 is an annular body including a tire bed, the spoke face 96, and first and second side walls 100 and 102 extending from the spoke face 96 to the tire bed. The tire 72 engages and is supported by the rim 70. FIGS. 3 and 5-21 illustrate example implementations of rim configurations under the present invention.

Referring to FIG. 3, one example implementation of the wheel assembly 14 including the rim 70 and the tire 72 is illustrated as wheel assembly 114 including a rim 170 and a tire 172. The rim 170 is symmetrical about a central radial axis 120. The rim 170 is a hollow annular tubular body formed by the spoke face 96, a tire bed 198 and the first and second side walls 100 and 102 extending from the spoke face 96 to first and second side regions 174 and 176 of the tire bed 198. The tire bed 198 is a curved circumferential band including the first and second side regions 174 and 176 that are integrally formed to the first and second side walls 100 and 102, respectively. The first and second side walls 100 and 102 include first and second side wall extensions 104 and 106 that radially extend from the first and second opposing edge regions 174 and 176 and terminate at first and second outer radial edges 108 and 110, respectively. The first and second outer radial edges 108 and 110 can include a bulbous end region 190 for interlocking with the tire 172. The tire 172 is a clincher style tire including a pair of circular beads 192 defining annular opening 194. The beads 192 engage and interlock with the bulbous end regions 190 of the first and second outer radial edges 108 and 110 to seal the tire 172 when inflated to the rim 170. In one implementation, an inner tube can be positioned inside the tire 172. The tire 172 has a tire width, d. In one implementation, the tire width d is within the range of 25-32 mm. In another implementation, the tire width can be within the range of 20 to 130 mm. In other implementations, tire width of different sizes can be used. In one implementation, a maximum width w of the rim 170 is less than the tire width d. In another implementation, the maximum width w of the rim 170 can be equal to or greater than the tire width d.

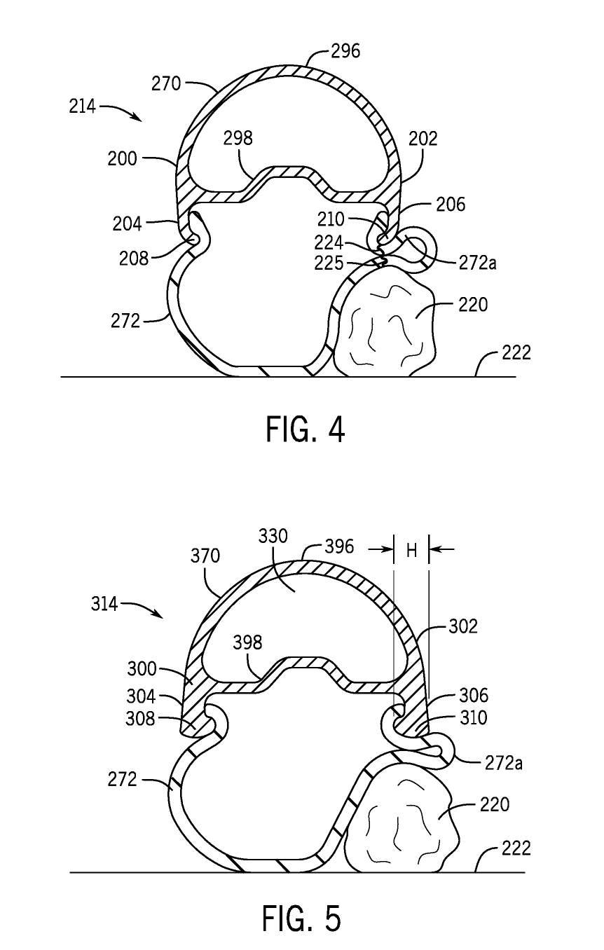

Referring to FIG. 4, a conventional tire and rim assembly 214 is illustrated with a tire 270 mounted to a rim 272. The rim 270 includes a spoke face 296, a tire bed 298 and first and second side walls 200 and 202 extending from the spoke face 296 to the tire bed 298. The rim 270 also includes side wall extensions 204 and 206 which terminate in outer radial edges 208 and 210. The side wall extensions 204 and 206 are typically narrow, rigid and include a straight side design, with generally straight or generally flat outer surfaces. In order to reduce weight of the rim and wheel as a whole, conventional rims such as rim 272 include thin walled elements including the side wall extensions 204 and 206 and the outer radial edges 208 and 210. The thin-walled side wall extensions 2014 and 206 also provide a desirable level of flexibility to the rim 272. Accordingly, many existing rims include side walls with thin side wall extensions and narrow outer radial edges having a maximum thickness of less than 3 mm that allow for reduced rim weight and a desirable level of rim flexibility.

Existing rims however have a significant drawback. When the rider impacts a large object, such as a rock 220, on a road 222, the tire 272 typically significantly deflects about the rock 220 upon impact resulting in a pinching of a portion 272a of the tire 272 between the rock 220 and one of the thin-walled side wall extensions 206. The reduced thickness and shape of the side wall extension 206 and the narrow outer radial edge 210 can cut into the pinched portion 272a of the tire 272 often creating a tire rupture location 224 that causes a pinch flat or flat tire. In some instances, a second tire rupture location 225 can occur between the rock 220 and the thin-walled side wall extension 206. In other instances, a tire can rupture in both tire rupture locations 224 and 225. The rupture(s) occur due to the concentration of load or stress at the location between the rock and the side wall extension.

The present invention overcomes this significant drawback by significantly increasing the size the first and second outer radial edges of the first and second rim extensions of the rim. The enlarged curved outer radial edges of the rim provide a larger bearing surface for a tire bear against during an impact with an object thereby significantly reducing the pinching of the tire and significantly reducing the likelihood of a pinch flat occurring upon impact with a large object on the road.

FIG. 5 illustrates the improved response of a rim 370 of a tire and rim assembly 314 in accordance with one implementation of the present invention. The rim 370 includes a spoke face 396, a tire bed 398 and first and second side walls 300 and 302 extending from the spoke face 396 to the tire bed 398 to define an annular rim cavity 330. The first and second side walls 300 and 302 include first and second side wall extensions 304 and 306 that include enlarged curved first and second outer radial edges 308 and 310, respectively. The first and second outer radial edges 308 and 310 and the first and second side wall extensions 304 and 306 include a maximum width or wall thickness, H, that is at least 3.8 mm. In another implementation, the maximum width of the first and second outer radial edges 308 and 310 and the first and second side wall extensions 304 and 306 is at least 4.0 mm. In another implementation, the maximum width of the first and second outer radial edges 308 and 310 and the first and second side wall extensions 304 and 306 is at least 4.2 mm.

The enlarged maximum width of the first and second curved outer radial edges 308 and 310 provides increased surface area for a portion 272a of a tire 272 to bear against in the event the tire 272 impacts a large object, such as the rock 220, on the road 222. The enlarged curved surface area of the second outer radial edge 210 reduces the pressure and stress applied to any particular portion 272a of the tire 272 deflecting between the rock 220 and the rim 370. As a result, the likelihood of a pinch flat or rupture of the tire 270 with rim 370 upon impact with a large object such as the rock 220 on the road 22 is significantly reduced.

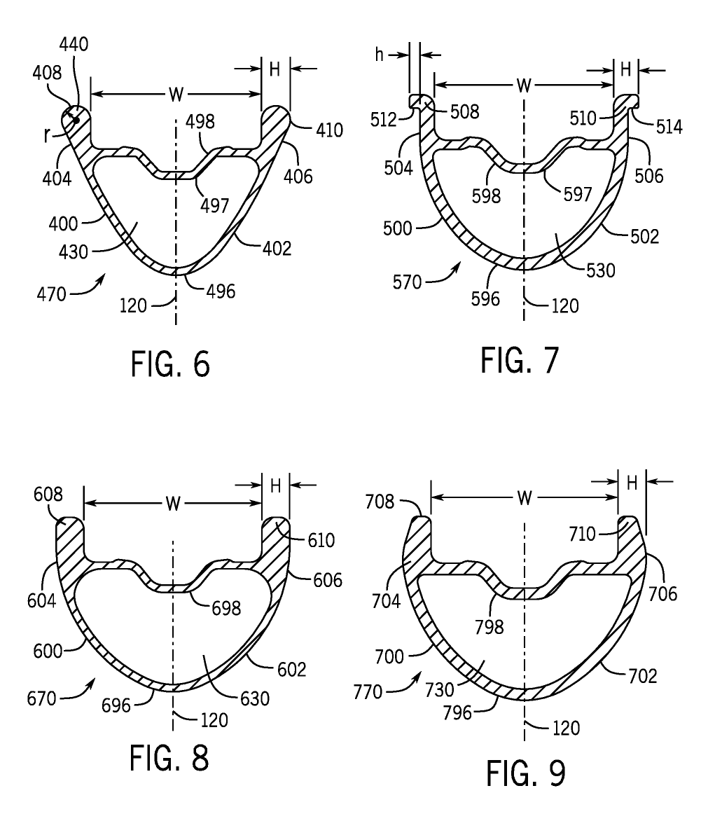

FIG. 6 is a radial cross-sectional view of a rim 470 in accordance with another implementation of the present invention. The rim 470 is symmetrical about the central radial axis 120 and includes a spoke face 496, a tire bed 498 and first and second side walls 400 and 402 extending from the spoke face 496 to the tire bed 498 to define an annular rim cavity 430. The tire bed 498 can include a recessed region 497. The first and second side walls 400 and 402 include first and second side wall extensions 404 and 406 that include enlarged curved first and second outer radial edges 408 and 410, respectively. The first and second outer radial edges 408 and 410 and the first and second side wall extensions 404 and 406 include a maximum width or wall thickness, H, that is at least 3.8 mm. The wall thickness of the first and second side wall extensions 404 and 406 can vary with respect to the central radial axis 120. In particular, the wall thickness of the first and second side wall extensions 404 and 406 can have a tire bed side wall extension thickness that is less than the maximum width or wall thickness of the first and second side wall extension 404 and 406 which occurs a location that outwardly, radially spaced from the wall thickness of the side wall extensions 404 and 406 at the tire bed (the tire bed side wall extension thickness). The first and second outer radial edges 408 and 410 can form a bulbous ridge 440. In one implementation, the first and second outer radial edges 408 and 410 forming the bulbous ridges 440 define a radial curved surface over an arc of at least 90 degrees, and the radial curved surface extends about a ridge radius, r, within the range of approximately, 1.9 mm-2.5 mm. The tire bed 498 has a tire bed width, W, within the range 20 to 100 mm. In one implementation, the tire bed width, W, could be within the range of 20 to 30 mm. The first and second outer radial edges 408 and 410 forming bulbous ridges 440 provide an enlarged surface area for a tire to bear against upon impact with an object, and reduces the likelihood of a pinch flat event occurring upon such an impact.

FIG. 7 is a radial cross-sectional view of a rim 570 in accordance with another implementation of the present invention. The rim 570 is substantially similar to the rim 470, except the rim 570 is a crochet-style rim. The rim 570 is symmetrical about the central radial axis 120, and includes a spoke face 596, a tire bed 598 and first and second side walls 500 and 502 extending from the spoke face 596 to the tire bed 598 to define an annular rim cavity 530. The tire bed 598 can include a recessed region 597. The first and second side walls 500 and 502 include first and second side wall extensions 504 and 506, respectively. The first and second side wall extension 504 and 506 terminate in first and second opposing and outwardly-extending first and second hooks 512 and 514 that form the first and second outer radial edges 508 and 510, respectively. The outwardly-extending hooks 512 and 514 extend away from the central radial axis 120. In one implementation, the hooks 512 and 514 include hook over hangs, h, that have a dimension of at least 1.0 mm. In another implementation, the hook overhangs, h, of the hooks 512 and 514 can have a dimension of at least 1.2 mm. The first and second outer radial edges 508 and 510 and the first and second side wall extensions 504 and 506 include a maximum width or wall thickness, H, that is at least 3.8 mm. The wall thickness of the first and second side wall extensions 504 and 506 radially inward of the hooks 512 and 514 can be generally constant with respect to the central radial axis 120. In another implementation, the wall thickness of the first and second side wall extensions 504 and 506 radially inward of the hooks 512 and 514 can vary with respect to the central radial axis 120. The tire bed 598 has a tire bed width, W, within the range 20 to 100 mm. In one implementation, the tire bed width, W, could be within the range of 20 to 30 mm. The first and second outer radial edges 508 and 510 provide an enlarged surface area for a tire to bear against upon impact with an object, and reduces the likelihood of a pinch flat event occurring upon such an impact.

FIG. 8 is a radial cross-sectional view of a rim 670 in accordance with another implementation of the present invention. The rim 670 is substantially similar to the rim 470, except the rim 670 is a straight side style rim. The rim 670 is symmetrical about the central radial axis 120 and includes a spoke face 696, a tire bed 698 and first and second side walls 600 and 602 extending from the spoke face 696 to the tire bed 698 to define an annular rim cavity 630. The first and second side walls 600 and 602 include first and second side wall extensions 604 and 606 that include enlarged curved first and second outer radial edges 608 and 610, respectively. The first and second outer radial edges 608 and 610 and the first and second side wall extensions 604 and 606 include a maximum width or wall thickness, H, that is at least 3.8 mm. The wall thickness of the first and second side wall extensions 604 and 606 is generally constant with respect to the central radial axis 120, and is substantially equal to the maximum width, H, along its length. The tire bed 698 has a tire bed width, W, within the range 20 to 100 mm. In one implementation, the tire bed width, W, could be within the range of 20 to 30 mm. The first and second outer radial edges 608 and 610 provide an enlarged surface area for a tire to bear against upon impact with an object, and reduces the likelihood of a pinch flat event occurring upon such an impact. The outer surfaces of first and second side wall extensions 604 and 606 can have a very gradual curvature or camber that, when used with a rim-based or caliper brake system, can serve as brake pad contact regions for engagement with brake pads of the rim-based brake system.

FIG. 9 is a radial cross-sectional view of a rim 770 in accordance with another implementation of the present invention. The rim 770 is substantially similar to the rim 470 except for the configuration of the side wall extensions. The rim 770 is symmetrical about the central radial axis 120 and includes a spoke face 796, a tire bed 798 and first and second side walls 700 and 702 extending from the spoke face 796 to the tire bed 798 to define an annular rim cavity 730. The first and second side walls 700 and 702 include first and second side wall extensions 704 and 706 that include enlarged curved first and second outer radial edges 708 and 710, respectively. The first and second outer radial edges 708 and 710 and the first and second side wall extensions 704 and 706 include a maximum width or wall thickness, H, that is at least 3.8 mm. The wall thickness of the first and second side wall extensions 704 and 706 can vary with respect to the central radial axis 120. In particular, the maximum width or wall thickness, H, of the first and second side wall extensions 704 and 706 can occur at a tire bed side wall extension thickness. Thickness of the first and second side wall extensions 704 and 706 can then gradually decrease as the rim 770 radially extends outward. In this configuration the first and second outer radial edges 708 and 710 extend over most of the surface area of the first and second side wall extensions 704 and 706. The tire bed 798 has a tire bed width, W, within the range 20 to 100 mm. In one implementation, the tire bed width, W, could be within the range of 20 to 30 mm. The first and second outer radial edges 708 and 710 provide an enlarged surface area for a tire to bear against upon impact with an object, and reduces the likelihood of a pinch flat event occurring upon such an impact.

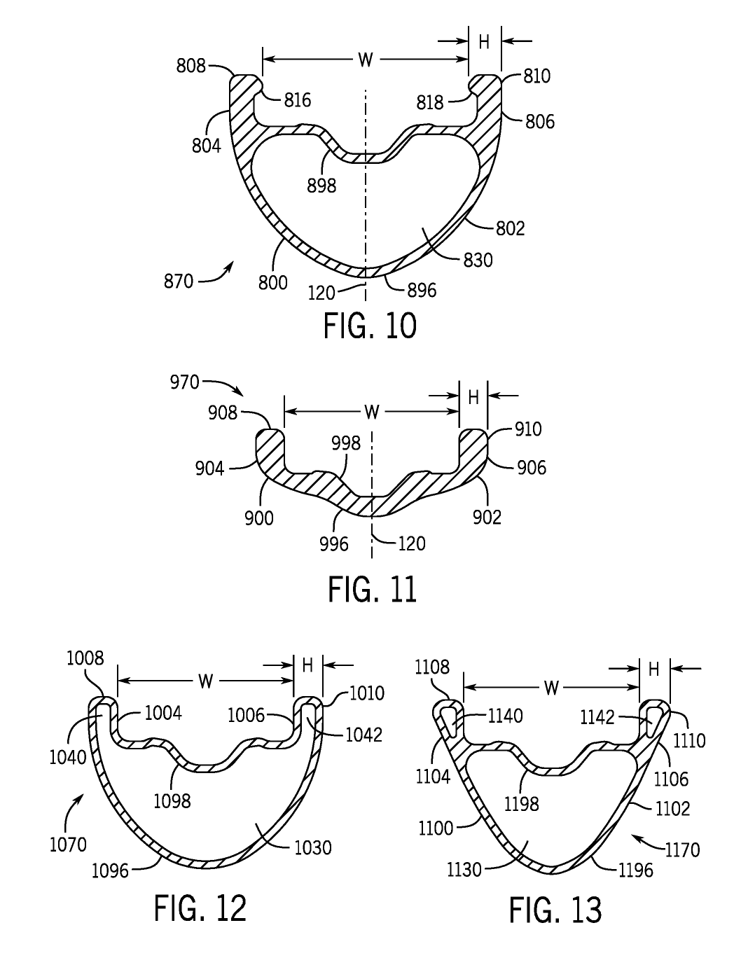

FIG. 10 is a radial cross-sectional view of a rim 870 in accordance with another implementation of the present invention. The rim 870 is substantially similar to the rim 670. The rim 870 is symmetrical about the central radial axis 120, and includes a spoke face 896, a tire bed 898 and first and second side walls 800 and 802 extending from the spoke face 896 to the tire bed 898 to define an annular rim cavity 830. The first and second side walls 800 and 802 include first and second side wall extensions 804 and 806, respectively. The first and second side wall extension 804 and 806 terminate in first and second opposing and inwardly-extending first and second projections 816 and 818 that form the first and second outer radial edges 808 and 810, respectively. The inwardly-extending projections 816 and 818 toward from the central radial axis 120. The first and second outer radial edges 808 and 810 and the first and second side wall extensions 804 and 806 include a maximum width or wall thickness, H, that is at least 3.8 mm. The tire bed 898 has a tire bed width, W, within the range 20 to 100 mm. In one implementation, the tire bed width, W, could be within the range of 20 to 30 mm. The first and second outer radial edges 808 and 810 provide an enlarged surface area for a tire to bear against upon impact with an object, and reduces the likelihood of a pinch flat event occurring upon such an impact.

FIG. 11 is a radial cross-sectional view of a rim 970 in accordance with another implementation of the present invention. The rim 970 is a solid, non-hollow structure that is symmetrical about the central radial axis 120. The rim 970 offers a low rim height that is desirable for certain applications. The rim 970 includes a spoke face 996 and a tire bed 998 that are formed as one integral piece such that the spoke face 996 is the lower (or radially inward) region of the rim 970 and the tire bed 998 is the upper (or radially outward) region of the rim 970. First and second side walls 900 and 902 radially outwardly extend from each side of the rim 970. The first and second side walls 900 and 902 include first and second side wall extensions 904 and 906 that include enlarged curved first and second outer radial edges 908 and 910, respectively. The first and second outer radial edges 908 and 910 and the first and second side wall extensions 904 and 906 include a maximum width or wall thickness, H, that is at least 3.8 mm. The tire bed 998 has a tire bed width, W, within the range 20 to 100 mm. In one implementation, the tire bed width, W, could be within the range of 20 to 30 mm. The first and second outer radial edges 908 and 910 provide an enlarged surface area for a tire to bear against upon impact with an object, and reduces the likelihood of a pinch flat event occurring upon such an impact.

FIG. 12 is a radial cross-sectional view of a rim 1070 in accordance with another implementation of the present invention. The rim 1070 is substantially similar to the rim 670, except the rim 1070 is an entirely hollow structure including the side wall extensions. The rim 1070 is symmetrical about the central radial axis 120 and includes a spoke face 1096, a tire bed 1098 and first and second side walls 1000 and 1002 extending from the spoke face 1096 to the tire bed 1098. The first and second side walls 1000 and 1002 include first and second side wall extensions 1004 and 1006 that include enlarged curved first and second outer radial edges 1008 and 1010, respectively. The first and second side wall extensions 1004 and 1006 can define annular first and second side wall channels 1040 and 1042. The spoke face 1096, the tire bed 1098 and the first and second side walls 1000 and 1000 define an annular rim cavity 1030, that is continuous with the first and second side wall channels 1040 and 1042 such that the rim 1070 is a thin-walled structure with the rim 1070 including the first and second side wall extensions 1004 and 1006 are hollow. The first and second outer radial edges 1008 and 1010 and the first and second side wall extensions 1004 and 1006 include a maximum width or wall thickness, H, that is at least 3.8 mm. The wall thickness of the first and second side wall extensions 1004 and 1006 is generally constant with respect to the central radial axis 120, and is substantially equal to the maximum width, H, along its length. The tire bed 1098 has a tire bed width, W, within the range 20 to 100 mm. In one implementation, the tire bed width, W, could be within the range of 20 to 30 mm. The first and second outer radial edges 1008 and 1010 provide an enlarged surface area for a tire to bear against upon impact with an object, and reduces the likelihood of a pinch flat event occurring upon such an impact.

FIG. 13 is a radial cross-sectional view of a rim 1170 in accordance with another implementation of the present invention. The rim 1070 is substantially similar to the rim 470, except the rim 1170 includes hollow side wall extensions. The rim 1170 is symmetrical about the central radial axis 120 and includes a spoke face 1196, a tire bed 1198 and first and second side walls 1100 and 1102 extending from the spoke face 1196 to the tire bed 1198. The first and second side walls 1100 and 1102 include first and second side wall extensions 1104 and 1106 that include enlarged curved first and second outer radial edges 1108 and 1110, respectively. The first and second side wall extensions 1104 and 1106 can define annular first and second side wall channels 1140 and 1142. The spoke face 1096, the tire bed 1098 and the first and second side walls 1000 and 1000 define an annular rim cavity 1130. The annular rim cavity 1130 is separate and spaced-apart from each of the first and second side wall channels 1140 and 1142. The first and second outer radial edges 1108 and 1110 and the first and second side wall extensions 1104 and 1106 include a maximum width or wall thickness, H, that is at least 3.8 mm. The tire bed 1198 has a tire bed width, W, within the range 20 to 100 mm. In one implementation, the tire bed width, W, could be within the range of 20 to 30 mm. The first and second outer radial edges 1108 and 1110 provide an enlarged surface area for a tire to bear against upon impact with an object, and reduces the likelihood of a pinch flat event occurring upon such an impact.

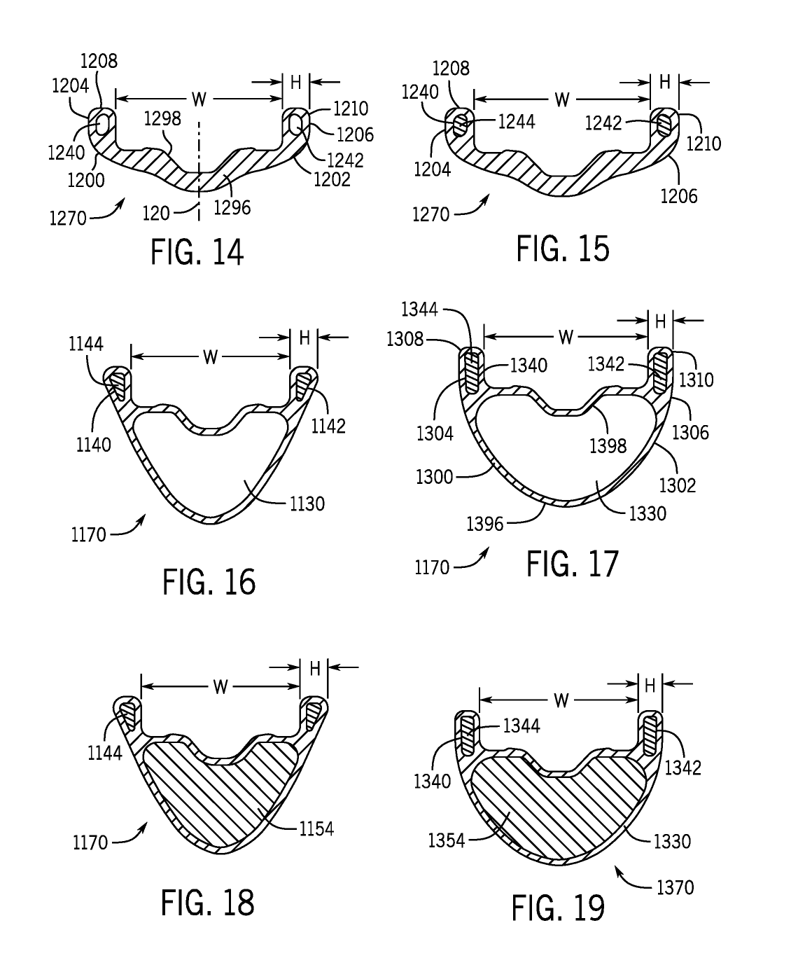

FIGS. 14 and 15 are a radial cross-sectional view of a rim 1270 in accordance with other implementations of the present invention. The rim 1270 is a solid, non-hollow structure that is symmetrical about the central radial axis 120. The rim 1270 offers a low rim height that is desirable for certain applications and is substantially similar to the rim 970. The rim 1270 includes a spoke face 1296 and a tire bed 1298 that are formed as one integral piece such that the spoke face 1296 is the lower (or radially inward) region of the rim 1270 and the tire bed 1298 is the upper (or radially outward) region of the rim 1270. First and second side walls 1200 and 1202 radially outwardly extend from each side of the rim 1270. The first and second side walls 1200 and 1202 include first and second side wall extensions 1204 and 1206 that include enlarged curved first and second outer radial edges 1208 and 1210, respectively. The first and second side wall extensions 1204 and 1206 can define annular first and second side wall channels 1240 and 1242. In FIG. 14, the first and second side wall channels 1240 and 1242 are empty such that the first and second side wall extensions 1204 and 1206 are hollow structures. In FIG. 15, the first and second side wall channels 1240 and 1242 can be filled with side wall channel fill material 1244. The side wall channel fill material 1244 can be formed of one or more lightweight materials, such as for example, a cellular foam, a non-cellular foam, cork, sponge, other elastomeric materials, and combinations thereof. The first and second outer radial edges 1208 and 1210 and the first and second side wall extensions 1204 and 1206 include a maximum width or wall thickness, H, that is at least 3.8 mm. The tire bed 1298 has a tire bed width, W, within the range 20 to 100 mm. In one implementation, the tire bed width, W, could be within the range of 20 to 30 mm. The first and second outer radial edges 1208 and 1210 provide an enlarged surface area for a tire to bear against upon impact with an object, and reduces the likelihood of a pinch flat event occurring upon such an impact.

Referring to FIG. 16, another implementation of the rim 1170 is illustrated. The annular first and second side wall channels 1140 and 1142 of first and second side wall extensions 1104 and 1106 can be filled with side wall channel fill material 1144. The side wall channel fill material 1144, like material 1244, can be formed of one or more lightweight materials, such as for example, a cellular foam, a non-cellular foam, cork, sponge, other elastomeric materials, and combinations thereof. The annular first and second side wall channels 1140 and 1142 of reduce the weight of the first and second side wall extensions 1104 and 1106 and the rim 1170 as a whole.

FIG. 17 is a radial cross-sectional view of a rim 1370 in accordance with another implementation of the present invention. The rim 1370 is substantially similar to the rim 670, except the rim 1370 includes hollow side wall extensions. The rim 1370 is includes a spoke face 1396, a tire bed 1398 and first and second side walls 1300 and 1302 extending from the spoke face 1396 to the tire bed 1398 to define an annular rim cavity 1330. The first and second side walls 1300 and 1302 include first and second side wall extensions 1304 and 1306 that include enlarged curved first and second outer radial edges 1308 and 1310, respectively. The first and second outer radial edges 1308 and 1310 and the first and second side wall extensions 1304 and 1306 include a maximum width or wall thickness, H, that is at least 3.8 mm. The first and second side wall extensions 1304 and 1306 can define annular first and second side wall channels 1340 and 1342. The spoke face 1396, the tire bed 1398 and the first and second side walls 1300 and 1302 define an annular rim cavity 1330. The annular rim cavity 1330 is separate and spaced-apart from each of the first and second side wall channels 1340 and 1342. In one implementation, the first and second side wall channels 1340 and 1342 be unfilled or hollow. In another implementation, the first and second side wall channels 1340 and 1342 can be filled with side wall channel fill material 1344. The side wall channel fill material 1344, like material 1244, can be formed of one or more lightweight materials, such as for example, a cellular foam, a non-cellular foam, cork, sponge, other elastomeric materials, and combinations thereof. The first and second outer radial edges 1308 and 1310 provide an enlarged surface area for a tire to bear against upon impact with an object, and reduces the likelihood of a pinch flat event occurring upon such an impact.

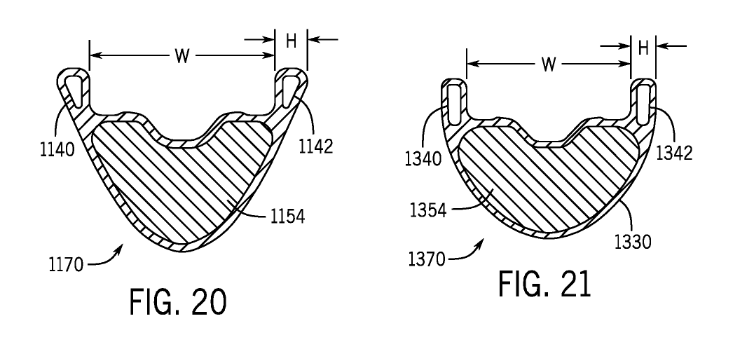

Referring to FIGS. 18 and 20, other implementations of the rim 1170 are illustrated. The spoke face 1196, the tire bed 1198 and the first and second side walls 1100 and 1102 define an annular rim cavity 1130. The annular rim cavity 1130 is separate and spaced-apart from each of the first and second side wall channels 1140 and 1142. The annular rim cavity 1130 can be filled with rim fill material 1154. The rim fill material 1154 can be formed of one or more lightweight materials, such as for example, a cellular foam, a non-cellular foam, cork, a silicone, a urethane, sponge, other elastomeric materials, and combinations thereof Referring to FIG. 18, the annular first and second side wall channels 1140 and 1142 of first and second side wall extensions 1104 and 1106 can be filled with side wall channel fill material 1144. In one implementation, the rim fill material 1154 can be the same material as the side wall channel fill material 1144. In another implementation, the rim fill material 1154 can be a different material that the side wall channel fill material 1144. Referring to FIG. 20, in another implementation, the annular first and second side wall channels 1140 and 1142 of first and second side wall extensions 1104 and 1106 can be unfilled.

Referring to FIGS. 19 and 21, other implementations of the rim 1370 are illustrated. The spoke face 1396, the tire bed 1398 and the first and second side walls 1300 and 1302 define an annular rim cavity 1130. The annular rim cavity 1330 is separate and spaced-apart from each of the first and second side wall channels 1340 and 1342. The annular rim cavity 1330 can be filled with rim fill material 1354. The rim fill material 1354 can be formed of one or more lightweight materials, such as for example, a cellular foam, a non-cellular foam, cork, a silicone, a urethane, sponge, other elastomeric materials, and combinations thereof Referring to FIG. 19, the annular first and second side wall channels 1340 and 1342 of first and second side wall extensions 1304 and 1306 can be filled with side wall channel fill material 1344. In one implementation, the rim fill material 1354 can be a different material that the side wall channel fill material 1344. In another implementation, the rim fill material 1354 can be the same material as the side wall channel fill material 1344. Referring to FIG. 21, in another implementation, the annular first and second side wall channels 1340 and 1342 of first and second side wall extensions 1304 and 1306 can be unfilled.

The rims 370 through 1370 can be formed of a lightweight, durable material, such as for example, a fiber composite material. As used herein, the terms “fiber composite material” refer to a plurality of fibers impregnated (or permeated throughout) with a resin. In one implementation, the fibers can be co-axially aligned in sheets or layers, braided or weaved in sheets or layers, and/or chopped and randomly dispersed in one or more layers. The composite material may be formed of a single layer or multiple layers comprising a matrix of fibers impregnated with resin. In particularly preferred embodiments, the number layers can range from 4 to 25. In other implementations, more than 25 layers can be used. In multiple layer constructions, the fibers can be aligned in different directions (or angles) with respect to an axis including 0 degrees, 90 degrees and angular positions between 0 to 90 degrees, and/or in braids or weaves from layer to layer. The fibers are formed of a high tensile strength material such as carbon. Alternatively, the fibers can be formed of other materials such as, for example, glass, graphite, boron, basalt, carrot, Kevlar®, Spectra®, poly-para-phenylene-2,6-benzobisoxazole (PBO), hemp and combinations thereof. In one set of preferred embodiments, the resin is preferably a thermosetting resin such as epoxy or polyester resins. In other sets of preferred embodiments, the resin can be a thermoplastic resin. The composite material is typically applied to a mold or wrapped about a mandrel and/or a comparable structure, and cured under heat and/or pressure. While curing, the resin is configured to flow and fully disperse and impregnate the matrix of fibers.

In another implementation, the rims 370 through 1370 can be formed of an aluminum alloy. In other implementations, the rims 370 through 1370 can be formed of other materials such as, a titanium alloy, steel, other alloys, a thermoplastic material, a thermoset material, wood, composite metal structures, metal matrix composite, other fiber composite materials and combinations thereof.

While the preferred embodiments of the invention have been illustrated and described, it will be appreciated that various changes can be made therein without departing from the spirit and scope of the invention. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically defined in this specification, the terminology used in the present specification is intended to be interpreted in its broadest reasonable manner, even though may be used conjunction with the description of certain specific embodiments of the present invention

What is claimed is:

1. A bicycle rim for carrying a tire, the rim comprising:
a circumferential tire bed including first and second opposing edge regions;
a circumferential spoke face; and
first and second side walls extending from the spoke face to the first and second edge regions, respectively, the first and second side walls including first and second side wall extensions radially extending from the first and second opposing side regions and terminating at first and second outer radial edges, respectively, each of the first and second outer radial edges defining a maximum width that is at least 3.8 mm.

2. The rim of claim 1, wherein each of the first and second outer radial edges defining a maximum width that is at least 4.0 mm.

3. The rim of claim 1, wherein each of the first and second outer radial edges defining a maximum width that is at least 4.2 mm.

4. The rim of claim 1, wherein the tire bed is spaced apart from the spoke face, and wherein the tire bed, the spoke face and the first and second side walls define an annular rim cavity.

5. The rim of claim 1, wherein the rim is a continuous, solid, non-hollow body with the tire bed integrally formed with the spoke face.

6. The rim of claim 4, wherein the annular rim cavity is filled with a rim fill material.

7. The rim of claim 6, wherein the rim fill material is selected from the group consisting of, a cellular foam, a non-cellular foam, cork, a silicone, a urethane, sponge, other elastomeric materials, and combinations thereof.

8. The rim of claim 1, wherein the first and second side wall extensions define first and second side wall channels, respectively.

9. The rim of claim 8, wherein the first and second side wall channels are filled with a side wall channel fill material.

10. The rim of claim 8, wherein the first and second side wall channels are continuous with the annular rim cavity.

11. The rim of claim 6, wherein the first and second side wall extensions define first and second side wall channels, respectively, and wherein the first and second side wall channels are filled with a side wall channel fill material.

12. The rim of claim 11, wherein the rim fill material and the side wall channel fill material are the same material.

13. The rim of claim 11, wherein the rim fill material and the side wall channel fill material are different materials.

14. The rim of claim 1, wherein the thickness of the first and second side wall extensions varies with respect to a radial axis.

15. The rim of claim 1, wherein the first and side walls include first and second straight side surfaces, respectively.

16. The rim of claim 1, wherein the first and second outer radial edges of the first and second opposing side regions are shaped to form opposing, outwardly-extending first and second hooks.

17. The rim of claim 16, wherein the first and second hooks include a hook overhang of at least 1.0 mm.

18. The rim of claim 16, wherein the first and second hooks include a hook overhang of at least 1.2 mm.

19. The rim of claim 1, wherein the first and second outer radial edges of the first and second opposing side regions are shaped to form opposing, inwardly-extending first and second projections.

20. The rim of claim 1, wherein the first and second side wall extensions are formed of a fiber composite material.

21. The rim of claim 1, wherein the first and second side wall extensions are formed of an aluminum alloy.

22. The rim of claim 1, wherein the first and second side wall extensions are formed of metal matrix composite material.
